(19) United States
(12) Patent Application Publication
(10) Pub. No.: US 2017/0277526 A1
(43) Pub. Date: Sep. 28, 2017

(54) Software categorization method and electronic device

(71) Applicants: Le Holdings (Beijing) Co., Ltd., Beijing (CN); LE SHI ZHI XIN ELETRONIC TECHNOLOGY (TIANJIN) LIMITED, Tianjin (CN)

(72) Inventor: Fengbing Shi, Tianjin (CN)

(21) Appl. No.: 15/242,530

(22) Filed: Aug. 21, 2016

Related U.S. Application Data
(63) Continuation of application No. PCT/CN2016/089541, filed on Jul. 10, 2016.

(30) Foreign Application Priority Data
Mar. 28, 2016 (CN) 2016101845038

(51) Int. Cl. G06F 9/445; H04L 29/08

(52) U.S. Cl. CPC G06F 8/61; H04L 67/34

(57) ABSTRACT

Embodiments of the present disclosure relate to the terminal field, and disclose a software categorization method and an electronic device, where the software categorization method includes: sending a software download request to a server; receiving a software information package that is sent by the server according to the software download request; determining a software category of to-be-installed software according to the software information package; and creating, according to the software category, an icon for the to-be-installed software in a file folder corresponding to the software category. According to the terminal, the server, and the software categorization method, a software icon for to-be-installed software can be automatically installed in a file folder for a software category corresponding to the to-be-installed software, and manual categorization by a user is not needed.

### CROSS-REFERENCE TO RELATED APPLICATIONS

The present disclosure is a continuation of PCT application No. PCT/CN2016/089541 submitted on Jul. 10, 2016, and claims priority to Chinese Patent Application No. 201610184503.8, filed with the Chinese Patent Office on Mar. 28, 2016, and entitled “TERMINAL, SERVER, AND SOFTWARE CATEGORIZATION METHOD” which is incorporated herein by reference in its entirety.

### TECHNICAL FIELD

The present disclosure relates to the terminal field, and in particular, to a terminal, a server, and a software categorization method.

### BACKGROUND

A user interface (User Interface, UI for short, also referred to as user interface) is a medium for interaction and information exchange between a system and a user. The user interface implements conversion between an internal form and a human acceptable form of information. The user interface is software related to interaction and communication between a user and hardware, and aims at enabling the user to conveniently and efficiently operate the hardware to implement bi-directional interaction and complete work intended to be completed in assistance of the hardware.

During implementation of the present invention, the inventor finds that, with rapid development of technologies nowadays, intelligent terminals, such as a mobile phone, a PDA (Personal Digital Assistant, personal digital assistant), and a tablet, have been well known by people, and there are also increasingly more various application software. Taking mobile phones as an example, a user generally installs various types of application software on a mobile phone of the user to provide convenience for daily life of the user, which results in a disorder of application software icons in a user interface of the mobile phone. Generally, these icons are mostly arranged according to installation time of the application software, which prevents the user to conveniently and easily find application software that the user intends to use in the user interface.

To facilitate location of these application software easily, the user may classify and reorganize these application software, for example, place application software of the social category in a file folder on the desktop, and place application software of the game category in another file folder on the desktop. However, currently, such work needs to be completed by manually dragging application software icons by the user, which costs relatively much effort and time.

### SUMMARY

An objective of some embodiments of the present disclosure is to provide a terminal, a software categorization method and an electronic device, which can implement automatically grouping software applications of a same category into a file folder for the category, and facilitate a user to quickly search, in a user interface, application software intended to be used.

According to a first aspect, an embodiment of this disclosure provides a software categorization method, which is applied to a terminal, where the method includes: sending a software download request to a server; receiving a software information package that is sent by the server according to the software download request; determining a software category of to-be-installed software according to the software information package; and creating, according to the software category, an icon for the to-be-installed software in a file folder corresponding to the software category.

According to a second aspect, an embodiment of this disclosure further provides a non-volatile computer storage medium, which stores a computer executable instruction, where the computer executable instruction is used to execute the foregoing software categorization method, which is based on a terminal, of this application.

According to a third aspect, an embodiment of this disclosure further provides an electronic device, including: at least one processor; and a memory communicably connected with the at least one processor for storing instructions executable by the at least one processor, where execution of the instructions by the at least one processor causes the at least one processor to execute the foregoing software categorization method, which is based on a terminal, of this application.

According to the software categorization method and electronic device provided in the embodiments of this application, similar applications may be automatically grouped into a category according to characteristics of the applications. For example, social chatting software (for example, WeChat, QQ, and momo) may be grouped into a social chatting software category, and game software (Plants vs. Zombies, Space Hunter, and Fantasy Westward Journey) may be grouped into a game software category. Therefore, manual categorization by a user is not needed.

Other features and advantages of the present disclosure are described in detail in the detailed description section below.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 shows a schematic structural diagram of a terminal according to some embodiments of the present disclosure;

FIG. 2 shows a schematic structural diagram of a control module of a terminal according to some embodiments of the present disclosure;

FIG. 3 shows a flowchart of a software categorization method based on a terminal according to some embodiments of the present disclosure;

FIG. 4 shows a flowchart of a software categorization method based on a terminal according to some embodiments;

FIG. 5 shows a schematic structural diagram of a server according to some embodiments of the present disclosure;

FIG. 6 shows a flowchart of a software categorization method based on a server according to some embodiments of the present disclosure; and

FIG. 7 is a schematic structural diagram of hardware of a device for executing a software categorization method, which is based on a terminal, according to some embodiments of the present disclosure.

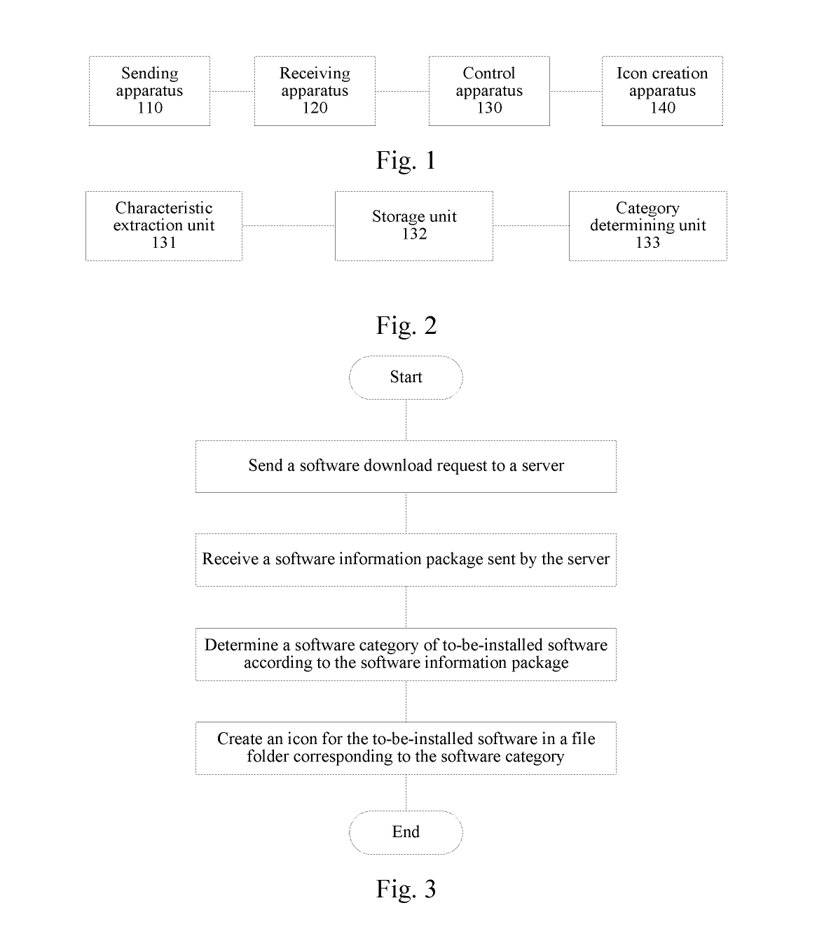

Description of appended reference numbers

| | | | |
|---|---|---|---|
| 110 | Sending apparatus | 120 | Receiving apparatus |
| 130 | Control apparatus | 140 | Icon creation apparatus |
| 131 | Characteristic extraction unit | 132 | Storage unit |
| 133 | Category determining unit | 310 | Receiving module |
| 320 | Category determining module | 330 | Sending module |
| 340 | Storage module | 710 | Processor |
| 720 | Memory | 730 | Input apparatus |
| 740 | Output apparatus | | |

### DETAILED DESCRIPTION

Specific embodiments of the present disclosure are described in detail below with reference to the accompanying drawings. It is to be understood that, the specific embodiments described herein are intended only to describe and explain the present disclosure, but not to limit the present disclosure.

FIG. 1 shows a schematic structural diagram of a terminal according to an embodiment of the present disclosure. As shown in FIG. 1, a terminal is provided according to an embodiment of the present disclosure, where the terminal may include: a sending apparatus 110, configured to send a software download request to a server; a receiving apparatus 120, configured to receive a software information package that is sent by the server according to the software download request; a control apparatus 130, configured to determine a software category of to-be-installed software according to the software information package; and an icon creation apparatus 140, configured to create, according to the software category, an icon for the to-be-installed software in a file folder corresponding to the software category. The terminal may implement automatically determining, when application software is to be installed, a software category of the to-be-installed software, and creating a software icon in a file folder for the category, to facilitate quick search when a user uses the software.

In an example, the software information package sent by the server includes a software installation package only. In this case, the control apparatus 130 needs to determine a software category of to-be-installed software according to the software installation package. First, a characteristic extraction unit 131 of the control apparatus 130 extracts characteristic information of the to-be-installed software from the software installation package, for example, extracts a software name of the to-be-installed software, a package name of the software package. A category determining unit 133 may compare the characteristic information (for example, the software name) with a software category list stored in a storage unit 132, and thereby determine the software category of the to-be-installed software. The software category list may store corresponding relation between software characteristic information and software categories. In an embodiment, the software category list may store a category of any software known in the prior art.

In addition, if the category determining unit 133 does not obtain a software category matched with the current to-be-installed software in the software category list, the sending apparatus 110 may send a request to the server to request the server to determine the software category of the to-be-installed software by searching the web, and then the server sends the determined software category to the receiving apparatus 120 of the terminal. In this case, the control apparatus 130 may be configured to update the software category list according to the characteristic information and the software category of the to-be-installed software.

Further, a user may be allowed to edit the application category list stored in the storage unit 132 in the control apparatus 130 to determine a software order in each software category. For example, when the user first uses the terminal, the user may be prompted to edit the category list, and the user may determine an application software order in each software category according to personal preferences. Thereby, when creating a software icon in a category file folder, the icon creation apparatus 140 may perform creation according to the software order.

In addition, the control apparatus 130 may also record a quantity of use times, by the user, of software installed on the terminal, and the icon creation apparatus 140 performs dynamic ordering on software in each software category according to the quantity of use times. For example, for game software, if a quantity of times of Space Hunter used by the user is greater than that of Plants vs. Zombies, the icon creation apparatus 140 may arrange an icon for Space Hunter before that of Plants vs. Zombies in a file folder for game software.

In another example, the foregoing software information package includes a software category and a software installation package, and the control apparatus 130 only needs to extract the software category from the software information package.

Further, the terminal provided in the present disclosure may further include: a determining apparatus, configured to determine whether the file folder corresponding to the software category exists in a user interface of the terminal; and a file folder creation apparatus, configured to create the file folder corresponding to the software category in the user interface if the file folder corresponding to the software category does not exist in the user interface.

FIG. 3 shows a flowchart of a software categorization method based on a terminal according to an embodiment of the present disclosure. Correspondingly, a software categorization method is further provided according to an embodiment of the present disclosure, where the method includes: sending a software download request to a server; receiving a software information package that is sent by the server according to the software download request; determining a software category of to-be-installed software according to the software information package; and creating, according to the software category, an icon for the to-be-installed software in a file folder corresponding to the software category.

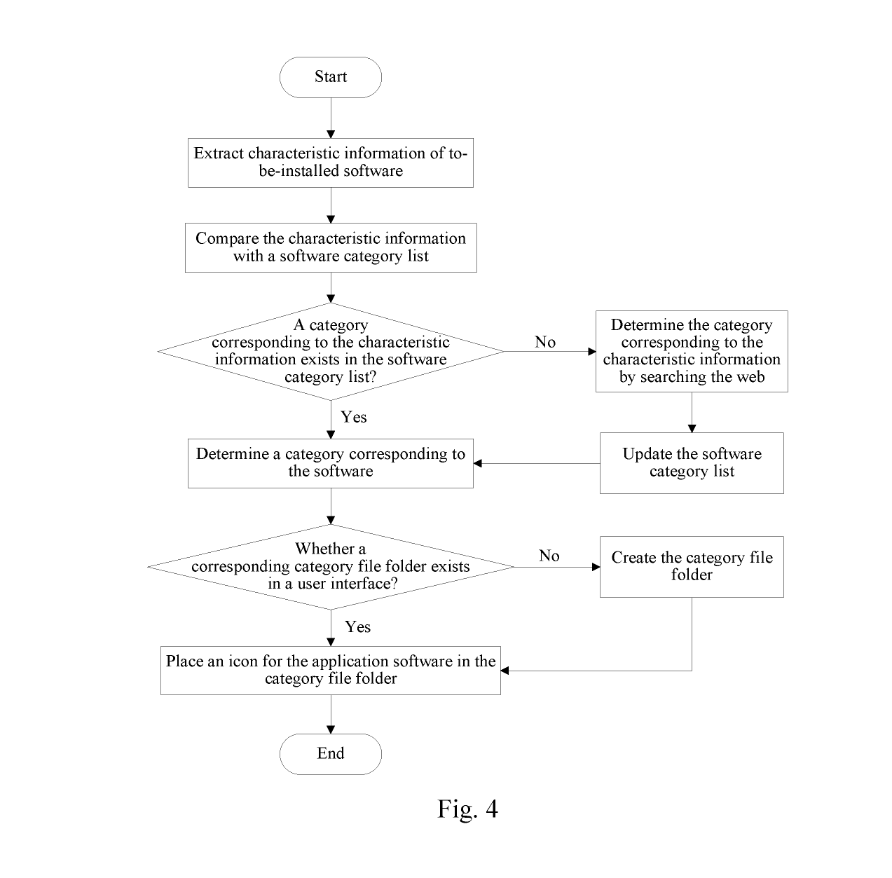

In an example, the software information package sent by the server may include a software installation package only. FIG. 4 shows a flowchart of a software categorization method based on a terminal according to an embodiment. As shown in FIG. 4, the foregoing software categorization method may further include: extracting characteristic information of the to-be-installed software from the software installation package, for example, extracts a software name of the to-be-installed software, a package name of the software package. Then, the extracted characteristic information is compared with a software category list to determine the software category of the to-be-installed software. The software category list may store corresponding relation between software characteristic information and software categories. In an embodiment, the software category list may store a category of any software known in the prior art.

Further, if a software category matched with the current to-be-installed software is not obtained in the software category list, that is, a category corresponding to the characteristic information does not exist in the software category list, a request may be sent to the server to request the server to determine the software category of the to-be-installed software by searching the web, then the software category sent by the server is received, and then the software category list may be updated according to the characteristic information and the software category of the to-be-installed software.

The method further includes: determining whether the file folder corresponding to the software category exists in a user interface; and creating the file folder corresponding to the software category in the user interface if the file folder corresponding to the software category does not exist in the user interface, and placing the icon for the to-be-installed software in the file folder.

In another example, the foregoing software information package includes a software category and a software installation package, and the software category may be directly extracted from the software information package.

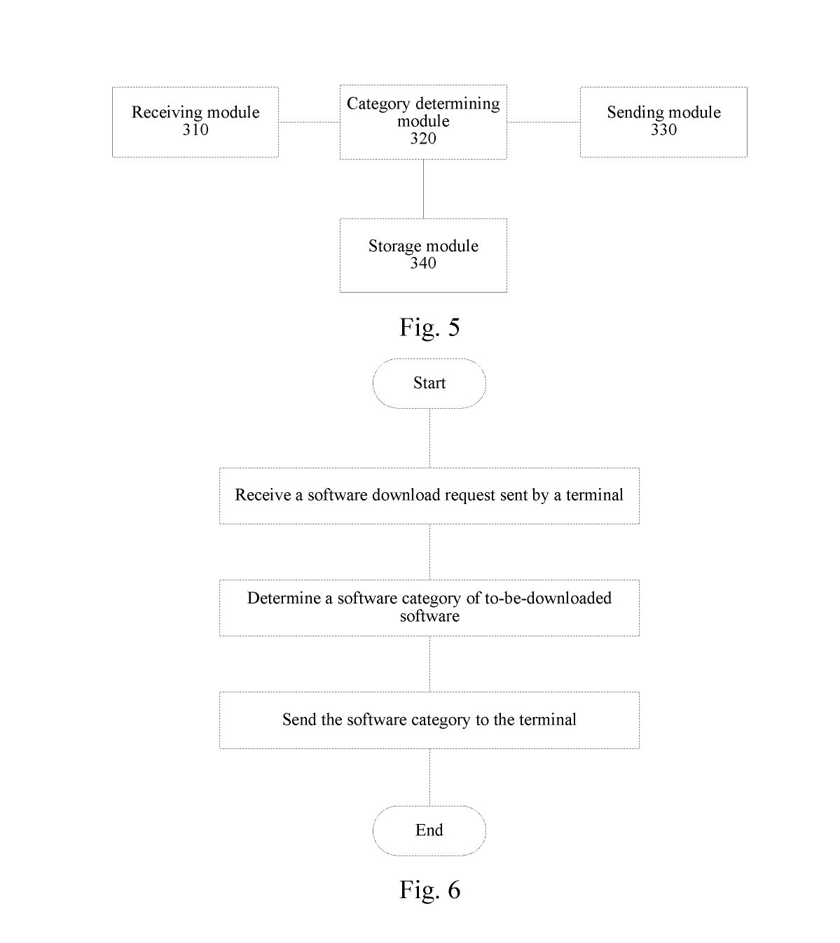

FIG. 5 shows a schematic structural diagram of a server according to another embodiment of the present disclosure. As shown in FIG. 5, correspondingly, a server is further provided in the present disclosure, where the server includes: a receiving module 310, configured to receive a software download request sent by a terminal; a category determining module 320, configured to determine a software category of to-be-downloaded software in response to the software download request; and a sending module 330, configured to send the software category of the to-be-downloaded software to the terminal.

In addition, the server may further include: a storage module 310, configured to store a software category list, and the category determining module is further configured to determine the software category of the to-be-downloaded software according to the software category list. The software category list may store corresponding relation between software characteristic information (for example, software names) and software categories. In an example, the software category list may store categories of all software included in a software database of the server. If new software is added to the software database, the server may determine a category of the new software according to description information of the new software or by searching on the Internet, and update in real time the software category list according to characteristic information and the software category of the new software.

FIG. 6 shows a flowchart of a software categorization method based on a server according to another embodiment of the present disclosure. As shown in FIG. 6, a software categorization method is further provided in the present disclosure, including: receiving a software download request sent by a terminal; determining a software category of to-be-downloaded software in response to the software download request; and sending the software category of the to-be-downloaded software to the terminal. In an example, as described above, the software category of the to-be-downloaded software may be determined according to a software category list.

By means of the terminal, the server, and the software categorization method in the present disclosure, a software icon for to-be-installed software may be automatically installed in a file folder for a software category corresponding to the to-be-installed software. For example, icons for social software such as WeChat, QQ, and momo may be automatically created in a file folder for a social chatting software category, and icons for game software such as Plants vs. Zombies, Space Hunter, and Fantasy Westward Journey may be automatically created in a file folder for game software. Therefore, manual categorization by a user is not needed.

In another example, a non-volatile computer storage medium is provided, which stores a computer executable instruction, where the computer executable instruction can execute the software categorization method, which is based on a terminal, provided in any foregoing method embodiment.

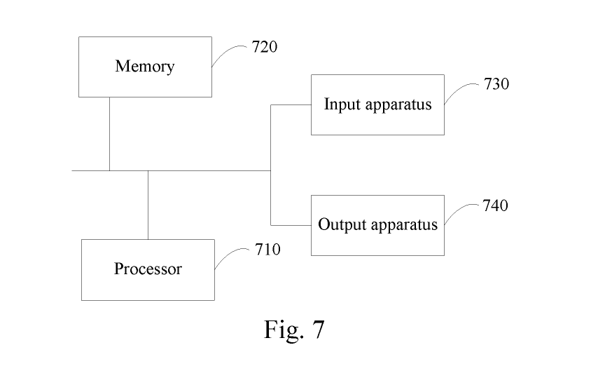

FIG. 7 is a schematic structural diagram of hardware of a device for executing the software categorization method, which is based on a terminal, provided in an embodiment of this apparatus. As shown in FIG. 7, the device includes:

one or more processors 710 and a memory 720, where only one processor 710 is used as an example in FIG. 7.

The device for executing the software categorization method, which is based on a terminal, may further include: an input apparatus 730 and an output apparatus 740.

The processor 710, the memory 720, the input apparatus 730, and the output apparatus 740 can be connected by means of a bus or in other manners. A connection by means of a bus is used as an example in FIG. 7.

As a non-volatile computer readable storage medium, the memory 720 can be used to store non-volatile software programs, non-volatile computer executable programs and modules, for example, a program instruction/module (for example, the sending apparatus 110, the receiving apparatus 120, the control apparatus 130, and the icon creation apparatus 140 shown in FIG. 1) corresponding to the software categorization method, which is based on a terminal, in the embodiments of this application. The processor 710 executes various functional applications and data processing of the server, that is, implements the software categorization method, which is based on a terminal, of the foregoing method embodiments, by running the non-volatile software programs, instructions, and modules that are stored in the memory 720.

The memory 720 may include a program storage area and a data storage area, where the program storage area may store an operating system and an application that is needed by at least one function; the data storage area may store data created according to use of the terminal, and the like. In addition, the memory 720 may include a high-speed random access memory, or may also include a non-volatile memory such as at least one disk storage device, flash storage device, or another non-volatile solid-state storage device. In some embodiments, the memory 720 optionally includes memories that are remotely disposed with respect to the processor 710, and the remote memories may be connected, via a network, to the terminal device for providing multimedia content. Examples of the foregoing network include but are not limited to: the Internet, an intranet, a local area network, a mobile communications network, or a combination thereof.

The input apparatus 730 can receive entered digits or character information, and generate key signal inputs relevant to user setting and functional control of the terminal. The output apparatus 740 may include a display device, for example, a display screen.

The one or more modules are stored in the memory 720; when the one or more modules are executed by the one or more processors 710, the software categorization method, which is based on a terminal, in any one of the foregoing method embodiments is executed.

The foregoing product can execute the method provided in the embodiments of this application, and has corresponding functional modules for executing the method and beneficial effects. Refer to the method provided in the embodiments of this application for technical details that are not described in detail in this embodiment.

The electronic device in this embodiment of this application exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this application, rather than limit this application. Although this application is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this application.

What is claimed is:

1. A software categorization method, applied to a terminal,comprising:
sending a software download request to a server;
receiving a software information package that is sent by the server according to the software download request;
determining a software category of to-be-installed software according to the software information package; and
creating, according to the software category, an icon for the to-be-installed software in a file folder corresponding to the software category.

2. The categorization method according to claim 1, wherein the software information package is a software installation package, and the determining a software category of to-be-installed software according to the software information package comprises:
extracting characteristic information of the to-be-installed software from the software installation package; and
determining the software category of the to-be-installed software according to the characteristic information and the software category list.

3. The categorization method according to claim 1, wherein the software information package comprises a software category.

4. The categorization method according to claim 2, wherein the software information package comprises a software category.

5. The method according to claim 1, wherein the method further comprises:
determining whether the file folder corresponding to the software category exists in a user interface of the terminal; and
creating the file folder corresponding to the software category in the user interface if the file folder corresponding to the software category does not exist in the user interface.

6. The method according to claim 2, wherein the method further comprises:
determining whether the file folder corresponding to the software category exists in a user interface of the terminal; and
creating the file folder corresponding to the software category in the user interface if the file folder corresponding to the software category does not exist in the user interface.

7. A non-volatile computer storage medium storing computer executable instructions, wherein the computer executable instructions are configured to:
send a software download request to a server;
receive a software information package that is sent by the server according to the software download request;
determine a software category of to-be-installed software according to the software information package; and
create, according to the software category, an icon for the to-be-installed software in a file folder corresponding to the software category.

8. An electronic device, comprising:
at least one processor; and
a memory communicably communication with the at least one processor, wherein
the memory stores instructions executable by the at least one processor, wherein
execution of the instructions by the at least one processor causes the at least one processor to:
send a software download request to a server;
receive a software information package that is sent by the server according to the software download request;
determine a software category of to-be-installed software according to the software information package; and
create, according to the software category, an icon for the to-be-installed software in a file folder corresponding to the software category.

9. The non-volatile computer storage medium according to claim 7, wherein the software information package is a software installation package, and in the determining a software category of to-be-installed software according to the software information package, the instructions are configured to:
extract characteristic information of the to-be-installed software from the software installation package; and
determine the software category of the to-be-installed software according to the characteristic information and the software category list.

10. The non-volatile computer storage medium according to claim 7, wherein the software information package comprises a software category.

11. The non-volatile computer storage medium according to claim 9, wherein the software information package comprises a software category.

12. The non-volatile computer storage medium according to claim 7, wherein the instructions are configured to:
determine whether the file folder corresponding to the software category exists in a user interface of the terminal; and
create the file folder corresponding to the software category in the user interface if the file folder corresponding to the software category does not exist in the user interface.

13. The non-volatile computer storage medium according to claim 9, wherein the instructions are configured to:
determine whether the file folder corresponding to the software category exists in a user interface of the terminal; and
create the file folder corresponding to the software category in the user interface if the file folder corresponding to the software category does not exist in the user interface.

14. The electronic device according to claim 8, wherein the software information package is a software installation package, and in the determining a software category of to-be-installed software according to the software information package, the program is set to:
extract characteristic information of the to-be-installed software from the software installation package; and
determine the software category of the to-be-installed software according to the characteristic information and the software category list.

15. The electronic device according to claim 8, wherein the software information package comprises a software category.

16. The electronic device according to claim 14, wherein the software information package comprises a software category.

17. The electronic device according to claim 8, wherein the instructions are configured to:
determine whether the file folder corresponding to the software category exists in a user interface of the terminal; and
create the file folder corresponding to the software category in the user interface if the file folder corresponding to the software category does not exist in the user interface.

18. The electronic device according to claim 14, wherein the instructions are configured to:
determine whether the file folder corresponding to the software category exists in a user interface of the terminal; and
create the file folder corresponding to the software category in the user interface if the file folder corresponding to the software category does not exist in the user interface.
